(19) United States
(12) Patent Application Publication
(10) Pub. No.: US 2008/0251368 A1
(43) Pub. Date: Oct. 16, 2008

(54) INPUT DEVICE

(75) Inventors: Per Anders HOLMBERG, Lund (SE); Roland BENGTSSON, Bjarred (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/773,481

(22) Filed: Jul. 5, 2007

Related U.S. Application Data
(63) Continuation-in-part of application No. 11/734,465, filed on Apr. 12, 2007.

(51) Int. Cl. H01H 1/14

(52) U.S. Cl. 200/534

(57) ABSTRACT

An electronic device, e.g. a mobile telephone, may comprise an input device such as a rocker key device for operating functions in the electronic device. The input device may comprise a switch device with at least one switch pad mounted on a support structure, and an input actuator for actuating the switch device. Each switch pad comprises a plurality of press detection switches. Each press detection switch of the multiple press detection switches is configured to output a signal upon depression of the press detection switch, when the switch pad is actuated by means of the input actuator. Some embodiments of the present invention provide the user of a communication device with a more reliable input of data/commands and at the same time achieves a higher redundancy for such input. The invention also reduces the height of a portable electronic device and also the number of components required for doing this, and therefore reduces the cost of the device. Furthermore, the invention also provides a very low height and a flat shape of the actuator when implemented in a mobile device, whereby the use of the restricted space in such a device is optimized.

### CROSS REFERENCE TO RELATED APPLICATION

This application is a continuation-in-part of U.S. application Ser. No. 11/734,465, filed Apr. 12, 2007, the entire disclosure of which is incorporated herein by reference.

### TECHNICAL FIELD

The present invention relates in general to an input device for operating functions in an electronic device, wherein the input device comprises a switch device having a set of switches mounted on a support structure. Moreover, the input device according to the invention comprises a soft conductive actuator for actuating the switch device. Moreover, the present invention relates to an electronic device comprising the above input device for operating functions in the electronic device.

### DESCRIPTION OF RELATED ART

In order to meet an increasing demand from e.g. mobile phone users and smart phone users for increasingly advanced functions, mobile phone manufacturers such as Sony Ericsson Mobile Communications®, provide mobile phones and smart phones with increasingly advanced input/output devices. Such input/output devices include, but is not limited to, e.g. larger touch-sensitive displays, joysticks, rocker keys, etc. to operate various functions of the mobile telephones or smart phones. These input devices may be used in lap top computers together with touch pads that may be stroked and tapped by fingers to give the function of a mouse.

The European patent application EP 1 492 137 A1, filed on 26 Jun. 2003, discloses various arrangements of previously known rocker key devices. FIGS. 1A, 1B, 2A, 2B, 3A, 3B illustrate some of the rocker key devices disclosed in the above-mentioned European patent application. The rocker key device 1 shown in FIG. 1A has a rocker key 2, a select button 3, switches 4 (normally a dome), all of which are mounted on a support structure or switch pad 5, such as a Printed Circuit Board (PCB), for arrangement in e.g. a mobile telephone. With reference to FIG. 1B, an exploded bottom view of the rocker key device 1 in FIG. 1A is shown. The rocker key 2 is provided with actuator bosses 6 integrated with the rocker key 2 or in a supporting rubber for actuating the switches 4, when the rocker key 2 is actuated or depressed by a user. FIG. 2A illustrates an arrangement of the switches 4 in a four directional arrangement forming a part of a rocker key device or a joystick switch. The actuating directions are illustrated by the arrows 7. However, the increasing need for new functions and applications in e.g. mobile phones may require more actuating directions to be operated properly. In FIG. 2B a prior art arrangement to provide eight selectable directions, which is extended from the four directional arrangement shown in FIG. 1A, is illustrated. In this arrangement, four switches 4 are utilized, wherein one single switch is actuated for each of the four directions, i.e. 0°/90°/180°/270°(as illustrated by the arrows in FIG. 2A), and four additional directions 45°/135°/225°/315° (as illustrated by the arrows in FIG. 2B). Still another prior art arrangement providing eight selectable directions is based on eight switch domes positioned on 0°/45°/90°/135°/180°/225°/270°/315°, as shown in FIG. 3A. In this arrangement, a single switch 4 with a metal dome is actuated, i.e. the dome collapses short-circuiting a known switch device, shown in FIG. 4, comprising an outer metal ring 4a electrically connected to the metal dome, shown in FIGS. 1A-4, and an inner circle 4b, which the dome contacts when it collapses short-circuiting the outer ring 4a and the inner circle 4b, one switch at a time to select one of the eight directions, whereby only one signal is output for each direction, i.e. each short-circuiting, in a known way. An exemplary side view of a rocker key device 1 comprising eight switches 4, in accordance with the configuration of FIG. 3A, is shown in FIG. 3B.

A switch device of an input device such as those described hereinabove, e.g. as shown in FIG. 5, may suffer from relatively bad reliability over time. For example, since a single switch 4 is operable to output one associated signal only when actuating the single switch 4, if the single switch 4 for any reason gets damaged or stops to function properly during its lifetime, there is consequently a risk that this single switch 4 becomes malfunctioning or even inoperable. A rocker key device with an inoperable switch 4 may result in a malfunctioning rocker key device, since the inoperable switch 4 will no longer be available to output its associated signal properly. As a consequence, it will possibly no longer be possible to actuate directions associated with the unusable or damaged switch 4. This may be annoying for the user operating such malfunctioning rocker key device. This also gives a low redundancy and an insufficient reliability for such prior art input devices. Accordingly, there is a need for providing an improved input device using a switch device and/or a soft conductive actuator operatively connected therewith. In particular, there is a need for providing an input device that mitigate, alleviate or eliminate one or more of the above-mentioned deficiencies or disadvantages in the known prior art. More specifically, there is a need for providing a solution that makes a single input device more reliable over time, as compared to the known prior art.

### SUMMARY OF THE INVENTION

Accordingly, some embodiments of the present invention preferably seek to mitigate, alleviate or eliminate one or more of the above-identified deficiencies in the art and disadvantages singly or in any combination.

An aspect of the present invention relates to an input device comprising a switch device for mounting on a support structure of the input device and a soft conductive input actuator operatively connected to the switch device and adapted for mounting over the switch device, the switch device comprising at least one switch pad with a plurality of press detection switches, wherein the soft conductive input actuator is configured to make contact with at least one press detection switch of the plurality of press detection switches upon depression of the soft conductive input actuator against the switch pad such that a signal is output from the press detection switch.

In one embodiment, the switch pad comprises: a lower surface which is adapted to be attached to the support structure; and an upper surface; wherein the upper surface forms an actuator contacting surface for the plurality of press detection switches.

In one embodiment, at least one detection switch of the plurality of press detection switches is contacted simultaneously upon depression of the soft conductive input actuator.

In one embodiment, the number of contacted press detection switches, upon depression of the soft conductive input actuator when in use, is indicative of the pressure against the soft conductive input actuator.

In one embodiment, the press detection switch, which is contacted upon depression of the soft conductive input actuator when in use, is indicative of where on the soft conductive input actuator the pressure is applied.

In one embodiment, the plurality of press detection switches is evenly distributed in a matrix pattern throughout the upper surface of the switch pad.

In one embodiment, the matrix pattern comprises at least one column with a plurality of press detection switches and/or at least one row with a plurality of press detection switches, wherein the column and/or the row of press detection switches comprises different number of press detection switches.

In one embodiment, the plurality of press detection switches is distributed in a circular pattern on the upper surface of the switch pad.

In one embodiment, the soft conductive input actuator is made of a deformable material, which, in another embodiment, is conductive.

In one embodiment, the soft conductive input actuator has a touch surface and a contact surface facing the switch pad, which contact surface is configured to come in contact with the switch pad when the touch surface of the actuator is pressed towards the switch pad such that a signal is output from the switch device.

In one embodiment, the contact surface has a varying shape, and in another embodiment, the contact surface has an even shape.

In one embodiment, the contact surface has a conical or frustoconical shape, and, in another embodiment, a rounded shape.

In one embodiment, the contact surface is deformable.

In one embodiment, the soft conductive input actuator is a thin sheet, and in another embodiment, the soft conductive input actuator has en elongated shape.

In one embodiment, the soft conductive input actuator is hollow, and in another embodiment the soft conductive input actuator has a substantially constant thickness.

Another aspect of the present invention relates to a switch device for operating functions in an electronic device, comprising at least one switch pad mounted on a support structure, wherein the switch pad comprises a plurality of press detection switches, wherein each press detection switch of the plurality of press detection switches is configured to output a signal upon depression of the press detection switch.

In one embodiment, each switch pad comprises: a lower surface attached to the support structure, and an upper surface, wherein the plurality of press detection switches are provided on the upper surface.

In one embodiment, at least one press detection switch of the plurality of press detection switches is contacted simultaneously upon depression of the switch pad.

In one embodiment, the number of depressed press detection switches, upon depression of the switch pad when in use, is indicative of the pressure against the switch pad.

In one embodiment, the press detection switch, which is contacted upon depression of the switch pad when in use, is indicative of where on the switch pad the pressure is applied.

In one embodiment, each switch pad comprises a plurality of press detection switches and the plurality of press detection switches are evenly distributed in a matrix pattern mounted on the upper surface.

In one embodiment, the matrix pattern comprising at least one column with a plurality of press detection switches and/or at least one row with a plurality of press detection switches, wherein the column and/or the row of press detection switches comprises different number of press detection switches.

Yet another aspect of the present invention relates to an input actuator for operating functions in an electronic device, comprising: a soft conductive actuator, which is configured to actuate a switch device by coming into contact with the switch device upon depression of the soft conductive actuator such that a signal is output from the switch device.

In one embodiment, the soft conductive actuator is made of a deformable material, which, in another embodiment, is conductive.

In one embodiment, the soft conductive actuator has a touch surface and a contact surface facing the switch device, which contact surface is configured to come in contact with the switch device when the touch surface of the actuator is pressed towards the switch device.

In one embodiment, the contact surface has a varying shape, and, in another embodiment, the contact surface has an even shape. In yet another embodiment, the contact surface has a conical or frustoconical shape, and, in another embodiment, the contact surface has a rounded shape.

In one embodiment, the contact surface is deformable.

In one embodiment, the soft conductive input actuator is a thin sheet, while, in another embodiment, the soft conductive input actuator has en elongated shape, and, in yet another embodiment, the soft conductive input actuator is hollow.

In one embodiment, the sheet has a substantially constant thickness.

Still another aspect of the present invention relates to an electronic device comprising an input device for operating functions in the electronic device, the input device comprising a switch device comprising at least one switch pad mounted on a support structure; and an input actuator for actuating the switch device, wherein each switch pad comprises a plurality of press detection switches, wherein each press detection switch of the plurality of press detection switches is configured to output a signal upon depression of the switch pad by means of the input actuator.

In one embodiment, each switch pad comprises a lower surface attached to the support structure, and an upper surface, wherein the plurality of press detection switches are provided on the upper surface.

In one embodiment, at least one press detection switch of the plurality of press detection switches is depressible simultaneously upon depression of the switch pad.

In one embodiment, the number of contacted press detection switches, upon depression of the switch pad when in use, is indicative of the pressure against the switch pad.

In one embodiment, the press detection switch, which is contacted upon depression of the switch pad when in use, is indicative of where on the switch pad the pressure is applied.

In one embodiment, each switch pad comprises a plurality of press detection switches and said plurality of press detection switches are evenly distributed in a matrix pattern mounted on the upper surface.

In one embodiment, the matrix pattern comprises at least one column with a plurality of press detection switches and/or at least one row with a plurality of press detection switches, wherein the column and/or the row of press detection switches comprises different number of press detection switches.

In one embodiment, the electronic device is an electronic device from the group comprising: a portable radio communication equipment, a mobile radio terminal, a mobile telephone, a cellular telephone, a pager, a communicator, an electronic organizer, a smart phone, a computer, a game console, a remote control or game device.

In one embodiment, the electronic device comprises the input device according to any of the preceding embodiments relating thereto.

In one embodiment, the electronic device comprises the switch device according to any of the preceding embodiments relating thereto.

In one embodiment, the electronic device comprises the input actuator according to any of the preceding embodiments relating thereto.

The features of the above-mentioned embodiments can be combined in any combinations.

Some embodiments of the invention provide for an improved input device, switch device, and/or an input actuator for inputting information, commands and/or data to a communication device, e.g. an electronic device. As compared with the known prior art, it is an advantage with some embodiments of the invention that at least one press detection switch of the plurality of press detection switches is contacted simultaneously upon depression of the soft conductive input actuator despite the fact that other press detection switches are out of order. Thus, some embodiments of the present invention provide the user of a communication device with a more reliable input of data/commands and at the same time achieves a higher redundancy for such input.

It is an advantage of some embodiments of the invention that the input device withstands mechanical load better and also provides a better resistance against dust and/or dirt and oxidation for the input device, the switch device, the input detector and the electronic device. This is due to the fact that a plurality of digital devices in combination simulates an analogue function according to the invention. The invention also reduces the height of a portable electronic device and also the number of components required for doing this, and therefore reduces the cost of the device. Furthermore, the invention also provides a very low height and a flat shape of the actuator when implemented in a mobile device, whereby the use of the restricted space in such a device is optimized.

### BRIEF DESCRIPTION OF THE DRAWINGS

Further objects, features and advantages of the invention will appear from the following detailed description of the invention, wherein embodiments of the invention will be described in more detail with reference to the accompanying drawings, in which:

FIG. 1A is a schematic exploded top view of a prior art rocker key device;

FIG. 1B is a schematic exploded bottom view of the prior art rocker key device of FIG. 1A;

FIG. 2A is a schematic top view of four prior art switches arranged in four selectable directions of operation;

FIG. 2B is a schematic arrangement of the prior art switches in FIG. 2A with four additional directions of operation to be selected;

FIG. 3A is a schematic arrangement of eight individually selectable prior art switches providing eight selectable directions of operation;

FIG. 3B is a schematic side view of a prior art rocker key device comprising the arrangement of FIG. 3A;

FIG. 4 shows the prior art switch of FIGS. 1A-3B in more detail;

FIG. 5 illustrates a mobile telephone including an input device according to some embodiments of the invention;

FIG. 5A is a schematic side view of input devices according to some embodiments of the invention;

FIG. 5B is a schematic side view of an input device according to another embodiment of the invention;

FIG. 6 is a top view of a switch pad of the input device of FIG. 5A;

FIG. 6A is a top view of an embodiment of the switch pad of FIG. 6;

FIG. 6B is a top view of another embodiment of the switch pad of FIG. 6;

FIG. 6C is a top view of yet another embodiment of the switch pad of FIG. 6;

FIG. 6D is a top view of another embodiment of a switch in the switch pad of FIG. 6;

FIG. 7 is a top view of still another embodiment of the switch pad of FIG. 6;

FIG. 8 is a top view of another embodiment of the switch pad of FIG. 6;

FIG. 9 is a top view of another input device according to the invention;

FIG. 10 is a schematic side view of the input device in FIG. 9 in a non-active state;

FIG. 11 is another schematic side view of the input device in FIG. 10 in an active state;

FIG. 12 is a top view of the active area of the input device in FIG. 11;

FIG. 13 is yet another schematic side view of the input device in FIGS. 10 and 11 in yet another active state;

FIG. 14 is a top view of the active area of the input device in FIG. 13;

FIG. 15 is a side view of yet another input device according to the invention;

FIG. 16 is a top view of the active areas of the input devices in FIGS. 12 and 14 as projected down on the switch pads shown in FIGS. 6-8, and

FIG. 17A to 17D shows different embodiments of the input device of FIGS. 9-14.

### DETAILED DESCRIPTION OF EMBODIMENTS

Embodiments of the present invention will be described more fully herein-after with reference to the accompanying drawings, in which embodiments of the invention are shown. Like numbers refer to like elements throughout.

FIG. 4 illustrates an electronic device embodied as a mobile telephone 40. Embodiments of the invention may be implemented into a wide variety of electronic devices. The electronic device may e.g. be a mobile radio terminal, a pager, a communicator, a smart phone, a Personal Digital Assistant (PDA), an electronic organizer, a computer, a portable media player such as an MP3 player or an iPod™, etc. Reference will however be to a mobile telephone below, which is only for illustrative purpose and should not be considered as limiting to the embodiments of the invention set forth herein.

The mobile telephone 40 comprises an input device 1. The input device is, but is not limited to, a rocker key device 1, which also may be a select button or a flexible sheet to be pressed as a key pad or stroked/tapped as a touch pad (see FIG. 15), mounted on the mobile telephone and operatively connected to electronic circuits therein. The rocker key device 1 comprises a rocker key 2 and a select button 3 for selection or activation of different functions or applications of the mobile telephone 40. The input device 1 is, however, not limited by the select button 3, but can in some embodiments operate without it, or, as explained above, operate only as a select button. Further, the mobile telephone 40 comprises, but is not limited to, additional details intended for the normal operation of a mobile telephone. As is illustrated in FIG. 4, in this embodiment the mobile telephone 40 comprises a display 8, a microphone 9, a keypad 10, which also may be replaced by the present invention, with one or more keys or as a flexible sheet mounted taut, a speaker 11, an integrated antenna (not shown), a radio transceiver (not shown) etc., all of which are operatively connected to electronic circuits in the mobile telephone 40. All these additional details are not necessary for the operation of the various embodiments of the invention, but are provided for illustration purposes of details of a mobile telephone, in which embodiments of the invention may advantageously be used.

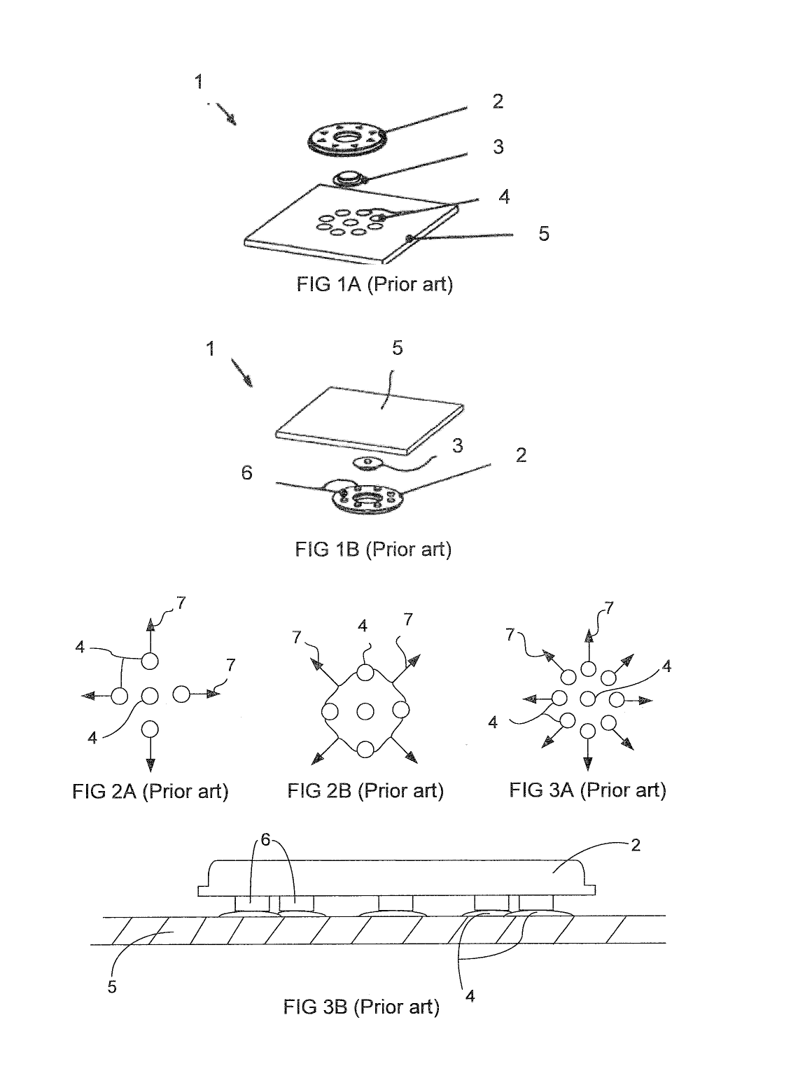

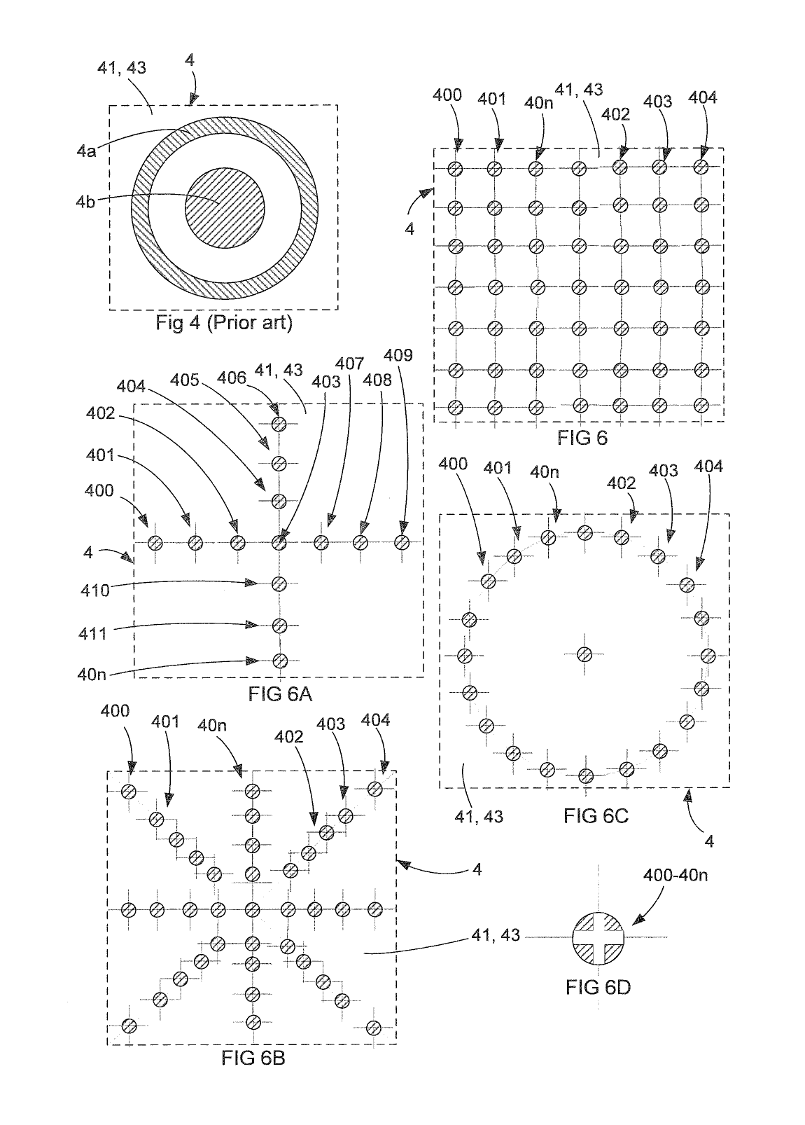

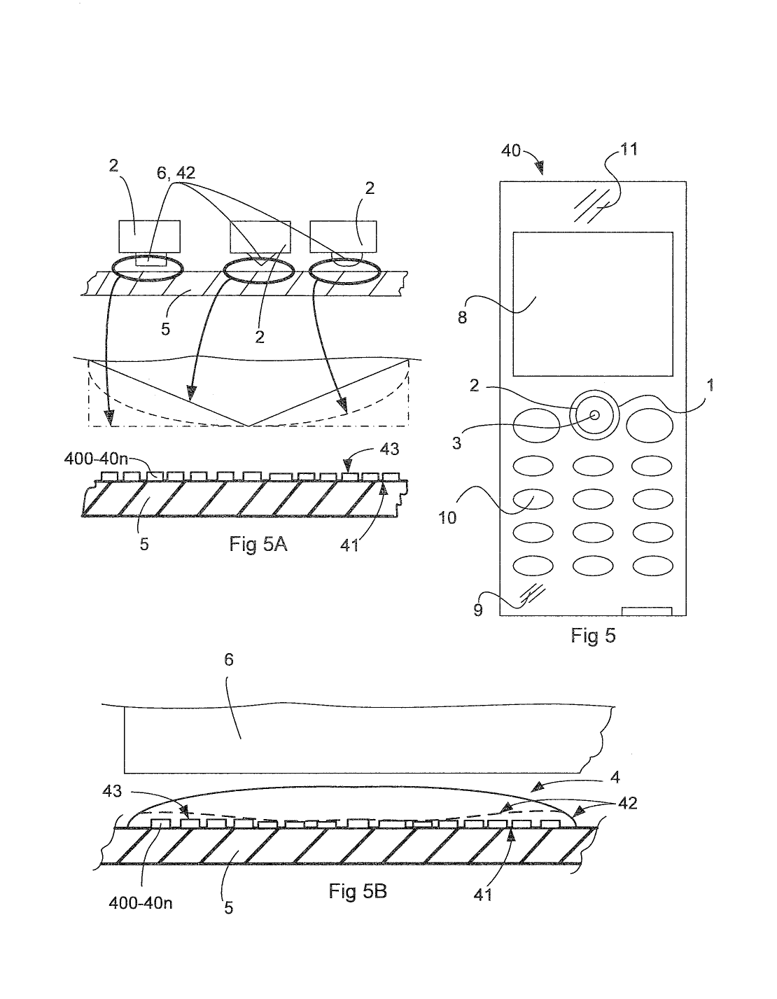

Embodiments of the present invention may be implemented into a wide variety of input devices 1, e.g., into prior art arrangements such as those illustrated in FIGS. 1A-B, 2A-B, 3A and 3B, and as a separate component, e.g. a wirelessly coupled/communicating device, which may be operatively connected to prior art input devices to be complementary to these. However, as a best mode of the invention presently known, embodiments of the invention may be implemented into the arrangements illustrated in FIGS. 5-17D.

Each input device 1 illustrated in FIGS. 5A-17D will now be described in further detail. The input device 1 comprises a lower surface 41 which is adapted to be attached to the support structure 5, e.g. a printed circuit board (PCB) or the like in a known way, and an upper surface 43. The lower surface may e.g. be flat. Furthermore, the input device 1 comprises an actuator surface 42 adapted to come in contact with the upper surface 43 and to come in contact with the switch device 4 comprising at least one press detection pad 400-40n. The actuator surface 42 faces the upper and the lower surface 41 and 43, as is illustrated in FIGS. 5A, 5B, 7-8, 10-11, 13, 15, and 17A-17D. The lower pad surface 41 according to embodiments of the invention preferably includes a plurality of press detection pads 400-40n, i.e. each pad surface 41 comprises a number of small press detection pads 400-40n, i.e. from a relatively small number of pads as shown in FIG. 6A-D to a large number of pads in FIGS. 6, 7-8, 16, i.e. at least two or more pads 400-40n on each pad surface 41.

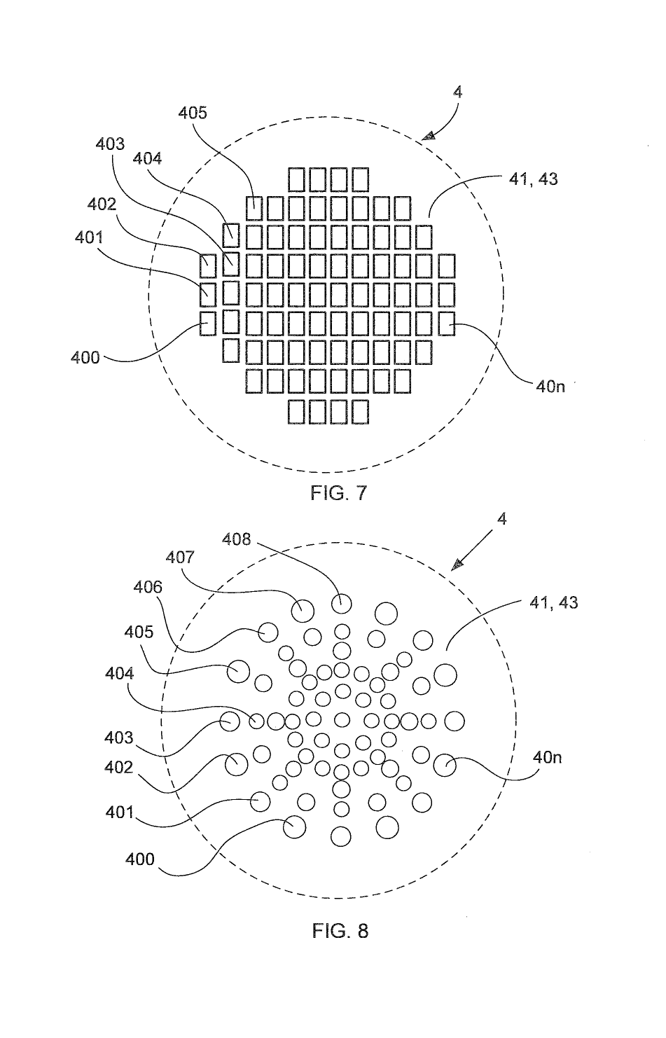

As is illustrated in FIG. 6, the multiple press detection pads may be provided on the area of the lower surface 41, which area is defined with a dotted line in a square shape as shown in FIGS. 6-6C, 12, 14, and 16 or a rounded shape as shown in FIGS. 7 and 8, this shape being irrelevant for the invention. In the embodiment shown in FIG. 6, there are 49 press detection pads 400-448. However, it should be appreciated that the exact number of press detection pads, more or less than 49 pads, can be varied in dependence of the purpose of the switch dome device and must hence be tested and evaluated in each specific case. The plurality of press detection pads 400-40n may be evenly distributed in a pattern, e.g. in a matrix pattern as illustrated in FIGS. 6, 7, and 16 or other shapes as shown in FIGS. 6A-C, throughout the lower surface 41 of the input device 1. In the embodiment of FIG. 6A, the plurality of press detection pads 400-412, i.e. thirteen pads, are arranged in columns and rows (7×7). In FIG. 7, the columns and rows of press detection pads may comprise different number of press detection pads 400-40n, e.g. more than two pads in each row and column. The invention is however not limited to the given positions of the press detection pads, but other configurations could also be possible within the scope of the invention. For example, in an alternative embodiment schematically illustrated in FIG. 7, the columns may comprise different number of press detection pads 400-40n (shown with square shapes) and, hence, also the rows may comprise different number of press detection pads, in this case 9 rows and 12 columns with a different number of pads except for the three middle rows and the four middle columns. Moreover, the pad pattern may be star shaped as shown in FIGS. 6B and 8, randomly shaped (not shown), circular as in FIG. 6C, square as in FIG. 6, i.e. quadratic or rectangular, triangular or the shapes may be combinations of different patterns, such as rhombic or other shapes, e.g. angular, figures, numerals, or letters. One or each of the press detection pads 400-40n may be split in four portions as shown in FIG. 6D, whereby this shape may give a reliable function for a joy stick in that each quarter and any suitable combination of these quarters when contacted by the actuator surface 6, 42 corresponds to one or more desired signals for input of information in the electronic device 40.

Each press detection pad of the plurality of press detection pads 400-40n is configured to output a signal upon depression of the press detection pad. Thus, upon depression of the input device 1, e.g. by means of the key 2 with its actuator boss 6, one or more press detection pads of said plurality of press detection pads are de-pressed simultaneously. Thus, when a user applies a force to the input device 1 by depressing the rocker key 2, the select button 3 or the key pad sheet having the combined function of a touch pad, the rocker key 2, and the select button 3 (see FIG. 15), one or more press detection pads 400-40n will be actuated, i.e. contacted and short-circuited simultaneously. Accordingly, all press detection pads that are actuated by the applied force will output a respective signal upon depression of the input device 1. Hence, contrary to a prior art switches which output only one single signal when the switch dome collapses after the input device is actuated or pressed, stroked or tapped, the press detection pads 400-40n of the switch 4 according to the embodiments of the present invention are operable to output multiple signals in response to how many press detection pads 400-40n that are contacted achieving an effect similar to an analogue signal, even though each separate detection pad is a digital device. This has the advantage that the reliability of an input device can be improved. This is because it is unlikely that all press detection pads 400-40n get damaged simultaneously or stop to function properly at the same time. So, if the input device 1 according to the invention for any reason would be effectuated by any external influence that could potentially harm the operation of the switch pads 5, the embodiments of the present invention allow for a reduced risk that the entire switch pad becomes completely inoperable. Even if one, a few or some of the press detection pads 400-40n were damaged or made inoperable for some reason, it would still be possible to actuate directions associated with the input device 1 since the rest or a sufficient number of the plurality of press detection pads would still be functioning properly, whereby some embodiments of the invention allow for a longer lifetime of the input device and also the electronic apparatus in which it is integrated.

Furthermore, when a user applies a force to the input device 1 by depressing the button 2, the number of actuated/contacted press detection pads 400-40n may be indicative of the pressure or force that is applied against the input device. Thus, it is possible to detect how hard, i.e. how many press detection pads are actuated, the user presses the input device 1. This may allow for providing a single input device with multiple functions similar to a touch pad on a laptop or a touch-sensitive display on the mobile phone 40 or similar portable electronic terminal. The multiple functions may be selected in dependence of the applied force to the input device. As only one illustrative example, it would be possible to utilize only a certain number of press detection pads 400-40n of the input device for a camera function. By detecting how hard the user presses the key, the input device could be provided with a double function such that when the user presses the key softly, contacting a certain number of pads, e.g. pads 400, 401, 402, it is possible to focus the camera and subsequently, when the user presses the key harder making contact with more pads, e.g. pads 403, 404, 405, a picture can be taken by means of the camera. Moreover, when a user applies a force to the input device 1 by depressing the key/button 2, 3, it is possible to detect where on the press detection pad surface 41 the pressure or force is applied depending on how many press detection pads 400-40n that are contacted and thereby short circuit in that moment.

When the user applies a force to the input device 1, the key/button 2 will collapse and/or be deformed, i.e. in one embodiment, the key is made of a flexible and conductive material, preferably a soft conductive plastic, silicone or rubber-like material, to different extent in dependence on how much force that is applied, a large force deforms the soft button and its soft actuator surface 42 or bosses 6 more than a smaller force, i.e. the larger deformation the bigger contact area A between the pads 400-40n and the button/key/touch pad (see FIGS. 12, 14, and 16), and hence different press detection pads and different numbers of pads will be actuated by electrical contact with the button in dependence of where on the input device 1 the force is applied and the amount of force used. Thus, the press detection pads that are actuated upon depression of the input device 1 are indicative of what area of the input device 1 and how large area of the pad surface 41 that are activated as a result of the applied pressure. Consequently, the input device having multiple press detection pads 400-40n according to embodiments of the invention may be operable to perform position detection and/or pressure level detection of an applied pressure when the user applies a force to the input device by depressing the button/key/touch pad 2, 3, 6, 42 against the lower surface 41. This has the further advantage that an input device 1 according to some embodiments of the invention may be provided with more functionality than what is offered by known prior art input devices.

A press detection pad 400-40n can have a small size, e.g. parts of a mm or less, e.g. two to ten times smaller or more than prior art input devices and their single rings 4a, and circles 4b, as shown in FIG. 4, This will make it possible to fit the input device according to the invention under today's normal buttons, key pads and touch pads with switches 4 that is 3-6 mm in diameter or to be adapted to the size of a desired set of keys, e.g. the whole or parts of the set of keys in the mobile phone 40.

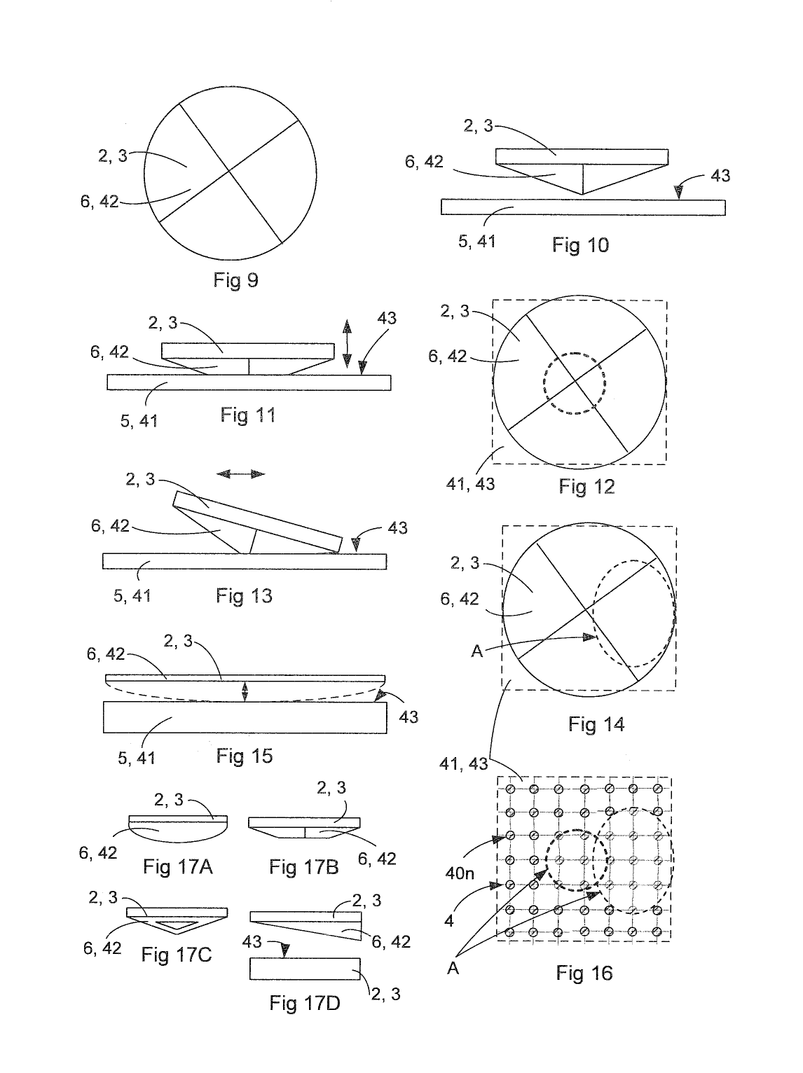

The material in the detection pads 400-40n shall be of a low resistance and be durable to wear and environmental stress, e.g. Au-plated or Ag-plated Cu-pads, ceramic low resistive material, for example Maxphase®, or similar material. The other connection side, i.e. the buttons/keys/touch pads 2, 3 to be actuated by fingers of the user, can be the known metal domes, as in prior art key pads in mobile phones, or the conductive sheet or button according to the invention, i.e. the soft button/rocker key 2, 3 in FIGS. 9-14 or the flexible sheet that is thin and that may be mounted taut/stretched over the detection pads 400-40n similar to a drumhead, as shown in FIG. 15, this material has a low resistance on the connection side, and is preferably sufficiently conductive so that a short circuit is achieved when contacting the switch pads 400-40n.

If the input device 1 is designed to give a pressure sensitive signal the number of detection pads 400-40n connected, i.e. short circuited, will vary dependent on how hard the user presses the button/touch pad 2, 3, 6, 42 against the pads and the pad surface 41, i.e. the contacting area increases due to deformation of the surface 6, 42 as the larger the force the bigger the deformation and contact area A (shown in FIG. 16). This will then correspond to the pressure level.

The multiple detection pads 400-40n can be produced with already know technology, as part of the wiring and layout of a PCB or flex film in the same way as the known pad shown in FIG. 4, i.e. the inventive pads 400-40n shown in FIGS. 6-8 and 16 are reduced in size at least between two and twenty times, preferably between three and fifteen times, and more preferably between four to ten times the size of the prior art pads shown in FIG. 4 to be fitted in a greater number on the same area 41 as the prior art pad.

FIGS. 5A, 10, 15 and 17A-17D shows the soft conductive actuator, i.e. button, key pad, or touch pad 2, 3 with differently shaped deformable lower surfaces for contacting the pads 400-40n: one actuator with a square cross-section in FIG. 5A; another actuator with a triangular cross-section forming a conical shape in FIGS. 5A and 10, another actuator with a rounded shape shown in FIGS. 5A and 17A, yet another actuator with a frustoconical shape in FIG. 17B, one actuator with an elongated triangular or wedge-shape in FIG. 17D with an upper side view and a lower view from above showing its rectangular shape, which of course may be quadratic, another actuator with a triangular hollow cross-section forming a non-solid conical shape in FIG. 17C, and one actuator in the form of a flexible sheet in FIG. 15. The actuators contact the switch pads 5 differently when pressed and deform differently, whereby the pad and actuator contacting areas A vary in size, this depend as explained earlier on how much force is applied by the user when actuating the input device 1.

The invention creates a parallel function in an input device instead of a serial function as in prior art input devices, whereby this provides a redundancy, i.e. a backup function, with a plurality of press detection pads backing up each other if one or more pads are “out of order”. This is done by processing many parallel signals as one direction or position defining parameter. A user of the invention may calibrate and adapt embodiments of the invention to desired function/sensitivity, i.e. different pressures may have different functions for different users. The invention increases the reliability for input devices, e.g. a prior art joy stick with five pads does not work if one pad is “out of order” while the invention still works as desired if any pad is defective. The invention may be used together with known domes as these domes may be deformed somewhat differently such that more than one pad may be contacted fulfilling, to some extent, the demands of the invention, but a soft pressure actuator instead of a metal dome is preferred according to the invention.

The terminology used herein describes particular embodiments only and is not intended to be limiting of the invention. As used herein, the singular forms “a”, “an” and “the” include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof. Unless otherwise defined, all terms (including technical and scientific terms) used herein have the same meaning as commonly understood by one of ordinary skill in the art. It will be further understood that terms used herein should be interpreted as having a meaning consistent with their meaning in the context of this specification and the relevant art and will not be interpreted in an idealized or overly formal sense unless expressly so defined herein. The present invention has been described above with reference to specific embodiments but other embodiments than those described are possible within the scope of the invention. The above-described embodiments should be regarded as illustrative rather than restrictive, and it should be appreciated that variations may be made in those embodiments by persons skilled in the art without departing from the scope of the present invention as defined by the appended claims.

What is claimed is:

1. An input device comprising a switch device for mounting on a support structure of the input device and a soft conductive input actuator operatively connected to the switch device and adapted for mounting over the switch device, the switch device comprising at least one switch pad with a plurality of press detection switches, wherein the soft conductive input actuator is configured to make contact with at least one press detection switch of the plurality of press detection switches upon depression of the soft conductive input actuator against the switch pad such that a signal is output from the press detection switch.

2. The input device according to claim 1, wherein the switch pad comprises: a lower surface which is adapted to be attached to the support structure; and an upper surface; wherein the upper surface forms an actuator contacting surface for the plurality of press detection switches.

3. The input device according to claim 2, wherein at least one press detection switch of the plurality of press detection switches is contacted simultaneously upon depression of the soft conductive input actuator.

4. The input device according to claim 3, wherein the number of contacted press detection switches, upon depression of the soft conductive input actuator when in use, is indicative of the pressure against the soft conductive input actuator.

5. The input device according to claim 3, wherein the press detection switch, which is contacted upon depression of the soft conductive input actuator when in use, is indicative of where on the soft conductive input actuator the pressure is applied.

6. The input device according to claim 2, wherein the plurality of press detection switches is evenly distributed in a matrix pattern throughout the upper surface of the switch pad.

7. The input device according to claim 6, wherein the matrix pattern comprises at least one column with a plurality of press detection switches and/or at least one row with a plurality of press detection switches, wherein the column and the row of press detection switches comprises different number of press detection switches.

8. The input device according to claim 2, wherein the plurality of press detection switches is distributed in a circular pattern on the upper surface of the switch pad.

9. The input device according to claim 1, wherein the soft conductive input actuator is made of a deformable material.

10. The input device according to claim 9, wherein the deformable material is conductive.

11. The input device according to claim 10, wherein the soft conductive input actuator has a touch surface and a contact surface facing the switch pad, which contact surface is configured to come in contact with the switch pad when the touch surface of the actuator is pressed towards the switch pad such that a signal is output from the switch device.

12. The input device according to claim 11, wherein the contact surface has a varying shape.

13. The input device according to claim 12, wherein the contact surface has an even shape.

14. The input device according to claim 11, wherein the contact surface has a conical or frustoconical shape.

15. The input device according to claim 11, wherein the contact surface has a rounded shape.

16. The input device according to claim 11, wherein the contact surface is deformable.

17. The input device according to claim 10, wherein the soft conductive input actuator is a thin sheet.

18. The input device according to claim 10, wherein the soft conductive input actuator has en elongated shape.

19. The input device according to claim 10, wherein the soft conductive input actuator is hollow.

20. The input device according to claim 18, wherein the soft conductive input actuator has a substantially constant thickness.

21. A switch device for operating functions in an electronic device, comprising:
at least one switch pad mounted on a support structure, wherein the switch pad comprises a plurality of press detection switches, wherein each press detection switch of the plurality of press detection switches is configured to output a signal upon depression of the press detection switch.

22. The switch device according to claim 21, wherein each switch pad comprises:
a lower surface attached to the support structure, and
an upper surface, wherein
the upper surface forms an actuator contacting surface for the plurality of press detection switches.

23. The switch device according to claim 22, wherein at least one press detection switch of the plurality of press detection switches is contacted simultaneously upon depression of the switch pad.

24. The press detection device according to claim 23, wherein the number of contacted press detection switches, upon depression of the switch pad when in use, is indicative of the pressure against the switch pad.

25. The switch device according to claim 23, wherein the press detection switch, which is contacted upon depression of the switch pad when in use, is indicative of where on the switch pad the pressure is applied.

26. The switch device according to claim 22, wherein each switch pad comprises a plurality of press detection switches and the plurality of press detection switches are evenly distributed in a matrix pattern mounted on the upper surface.

27. The switch device according to claim 21, wherein the matrix pattern comprises at least one column with a plurality of press detection switches and/or at least one row with a plurality of press detection switches, wherein the column and the row of press detection switches comprises different number of press detection switches.

28. An input actuator for operating functions in an electronic device, comprising: a soft conductive actuator, which is configured to actuate a switch device by coming into contact with the switch device upon depression of the soft conductive actuator such that a signal is output from the switch device.

29. The input actuator according to claim 28, wherein the soft conductive actuator is made of a deformable material.

30. The input actuator according to claim 29, wherein the deformable material is conductive.

31. The input actuator according to claim 30, wherein the soft conductive actuator has a touch surface and a contact surface facing the switch device, which contact surface is configured to come in contact with the switch device when the touch surface of the actuator is pressed towards the switch device.

32. The input actuator according to claim 31, wherein the contact surface has a varying shape.

33. The input actuator according to claim 31, wherein the contact surface has an even shape.

34. The input actuator according to claim 31, wherein the contact surface has a conical or frustoconical shape.

35. The input actuator according to claim 31, wherein the contact surface has a rounded shape.

36. The input actuator according to claim 31, wherein the contact surface is deformable.

37. The input actuator according to claim 30, wherein the soft conductive input actuator is a thin sheet.

38. The input actuator according to claim 30, wherein the soft conductive input actuator has an elongated shape.

39. The input actuator according to claim 30, wherein the soft conductive input actuator is hollow.

40. The input actuator according to claim 37, wherein the sheet has a substantially constant thickness.

41. An electronic device comprising an input device for operating functions in the electronic device, the input device comprising:
a switch device comprising at least one switch pad mounted on a support structure; and
an input actuator for actuating the switch device, wherein
each switch pad comprises a plurality of press detection switches, wherein each press detection switch of the plurality of press detection switches is configured to output a signal upon depression of the switch pad by means of the input actuator.

42. The electronic device according to claim 41, wherein each switch pad comprises:
a lower surface attached to the support structure, and
an upper surface, wherein
the upper surface forms an actuator contacting surface for the plurality of press detection switches.

43. The electronic device according to claim 42, wherein at least one press detection switches of the plurality of press detection switches are contacted simultaneously upon depression of the switch pad.

44. The electronic device according to claim 43, wherein the number of contacted press detection switches, upon depression of the switch pad when in use, is indicative of the pressure against the switch pad.

45. The electronic device according to claim 43, wherein the press detection switch, which is contacted upon depression of the switch pad when in use, is indicative of where on the switch pad the pressure is applied.

46. The electronic device according to claim 42, wherein each switch pad comprises a plurality of press detection switches and said plurality of press detection switches are evenly distributed in a matrix pattern mounted on the upper surface.

47. The electronic device according to claim 46, the matrix pattern comprising at least one column with a plurality of press detection switches and/or at least one row with a plurality of press detection switches, wherein the column and the row of press detection switches comprises different number of press detection switches.

48. The electronic device according to claim 41, wherein the electronic device is an electronic device from the group comprising: a portable radio communication equipment, a mobile radio terminal, a mobile telephone, a cellular telephone, a pager, a communicator, an electronic organizer, a smart phone, a computer, a game console, a remote control or game device.
